(19) United States
(12) Patent Application Publication
(10) Pub. No.: US 2021/0329740 A1
(43) Pub. Date: Oct. 21, 2021

(54) INDUSTRIAL MACHINE SYSTEM, METHOD OF COMMUNICATION AND WIRELESS ACCESS POINT

(71) Applicant: KABUSHIKI KAISHA YASKAWA DENKI, Kitakyushu-shi (JP)

(72) Inventors: Kazutoshi KOBAYASHI, Kitakyushu-shi (JP); Hidetsugu KOGA, Kitakyushu-shi (JP)

(73) Assignee: KABUSHIKI KAISHA YASKAWA DENKI, Kitakyushu-shi (JP)

(21) Appl. No.: 17/363,104

(22) Filed: Jun. 30, 2021

Related U.S. Application Data
(63) Continuation of application No. PCT/JP2019/002530, filed on Jan. 25, 2019.

(51) Int. Cl. H04W 88/08; H04W 4/38; H04W 56/00; H04L 29/08

(52) U.S. Cl. CPC H04W 88/085; H04W 4/38; H04L 67/125; H04W 56/001; H04W 56/0005

(57) ABSTRACT

An industrial machine system includes a slave device that is a component of an industrial machine, and a master device including circuitry that communicates with the slave device and control the slave device. The slave device and the master device are synchronized via a first wireless network, and communicate communication data for controlling the slave device via a second wireless network which is different from the first wireless network.

### CROSS-REFERENCE TO RELATED APPLICATIONS

The present application is a continuation of and claims the benefit of priority to International Patent Application No. PCT/JP2019/002530, filed Jan. 25, 2019, the entire contents of which are incorporated herein by reference.

### BACKGROUND OF THE INVENTION

### Field of the Invention

The present disclosure relates to an industrial machine system, a method of communication and a wireless access point.

### Description of Background Art

In an industrial machine system, to perform high-precision control, synchronization is achieved between devices connected to a network. As a method for the synchronization, a master device may transmit a synchronization packet (Sync) for every communication period, and a slave device may update (correct) its own clock based on a reception timing of the synchronization packet (see Japanese Patent Application Laid-Open Publication No. 2012-34224 and International Publication No. WO 2016/072038). The entire contents of these publications are incorporated herein by reference.

### SUMMARY OF THE INVENTION

According to one aspect of the present invention, an industrial machine system includes a slave device that is a component of an industrial machine, and a master device including circuitry that communicates with the slave device and control the slave device. The slave device and the master device are synchronized via a first wireless network, and communicate communication data for controlling the slave device via a second wireless network which is different from the first wireless network.

According to another aspect of the present invention, a method of communication of an industrial machine system includes synchronizing a slave device that is a component of an industrial machine, and a master device that communicates with the slave device and controls the slave device the master device via a first wireless network, and communicating, using the slave device and the master device, communication data for controlling the slave device via a second wireless network which is different from the first wireless network.

Yet another aspect of the present invention is a wireless access point of an industrial machine system including a slave device that is a component of an industrial machine and a master device that communicates with the slave device and controls the slave device. The wireless access point is connected to the master device via a wired network. The wireless access point includes circuitry that generates a wireless synchronization packet with a wireless synchronization period synchronized with at least one of a control period of the master device and a communication period of the master device, transmits the wireless synchronization packet to the slave device via a first wireless network, and communicates via a second wireless network communication data communicated with the master device via the wired network. The circuitry further generates the wireless synchronization packet with the wireless synchronization period based on a first synchronization packet received with a first communication period from the master device via the wired network.

Still another aspect of the present invention is a wireless access point of an industrial machine system including a slave device that is a component of an industrial machine and a master device that communicates with the slave device and controls the slave device. The wireless access point is connected to the slave device via a wired network. The wireless access point includes circuitry that receives via a first wireless network a wireless synchronization packet that is generated with a wireless synchronization period synchronized with at least one of a control period and a communication period of the master device, transmits to the slave device via the wired network a second synchronization packet for synchronizing at least one of a control period and a communication period of the slave device based on the wireless synchronization packet, and communicates via a second wireless network communication data communicated with the slave device via the wired network.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an example of an overall structure of an industrial machine system 1 according an embodiment of the present invention;

FIG. 2 illustrates an example of functional blocks of a wireless access point #0 used in the industrial machine system 1 according an embodiment of the present invention;

FIG. 3 illustrates an example of functional blocks of wireless access points #1/#2 used in the industrial machine system 1 according an embodiment of the present invention; and

FIGS. 4A-4D are for describing an example of a method of communication of the industrial machine system 1 according an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

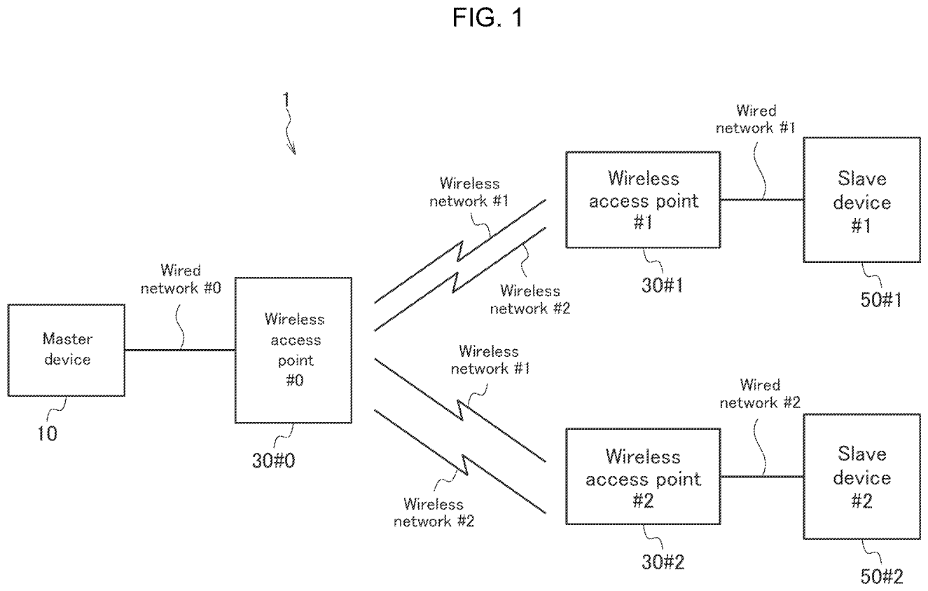

In the following, an embodiment is described with reference to FIGS. 1-4.

### Structure of Industrial Machine System

An example of a structure of an industrial machine system 1 according to the present embodiment is described below with reference to FIGS. 1-3.

As illustrated in FIG. 1, the industrial machine system 1 according to the present embodiment includes a master device 10, a wireless access point #0 (30 #0), a wireless access point #1 (30 #1), a wireless access point #2 (30 #2), a slave device #1 (50 #1), and a slave device #2 (50 #2).

The master device 10 is an industrial machine component that communicates with the slave devices #1/#2 and controls the slave devices #1/#2, and the slave devices #1/#2 are industrial machine components that communicate with the master device 10.

Specifically, as illustrated in FIG. 1, the master device 10 is connected to the wireless access point #0 via a wired network #0, the slave device #1 is connected to the wireless access point #1 via a wired network #1, and the slave device #2 is connected to the wireless access point #2 via a wired network #2. Here, the wired networks #0-#2 are each any communication system.

Further, the wireless access point #0 is connected to the wireless access point #1 via wireless networks #1/#2, and is also connected to the wireless access point #2 via the wireless networks #1/#2.

Here, it is structured that the slave devices #1/#2 and the master device 10 are synchronized via the wireless network #1 (first wireless network).

Further, it is structured that the slave devices #1/#2 and the master device 10 communicate communication data for controlling the slave devices via the wireless network #2 (second wireless network) which is different from the wireless network #1.

According to such structures, in the industrial machine system 1, even when the wireless networks are used, synchronization can be achieved between the master device 10 and the slave devices #1/#2, and high-precision control can be realized.

The same communication protocol may be used in the wireless network #1 and the wireless network #2.

Here, the wireless network #1 is a communication system having a constant periodicity (or regularity). According to such a structure, synchronization can be more reliably achieved between the master device 10 and the slave devices #1/#2 via the wireless network #1.

Further, the wireless network #2 is any communication system. For example, the wireless network #2 may be a communication system having a higher throughput than the wireless network #1. According to such a structure, since communication data can be communicated with a high throughput via the wireless network #2, high-precision control can be realized.

For example, it may be structured that the communication protocol used in the wireless network #1 is Bluetooth (registered trademark) or DECT (registered trademark, Digital Enhanced Cordless Telecommunications), and the communication protocol used in the wireless network #2 is any one of Wi-Fi (registered trademark), Bluetooth (registered trademark), and DECT (registered trademark).

According to such a structure, synchronization can be achieved between the master device 10 and the slave devices #1/#2 using a highly versatile wireless network, and an industrial machine system 1 using highly reliable wireless networks can be realized.

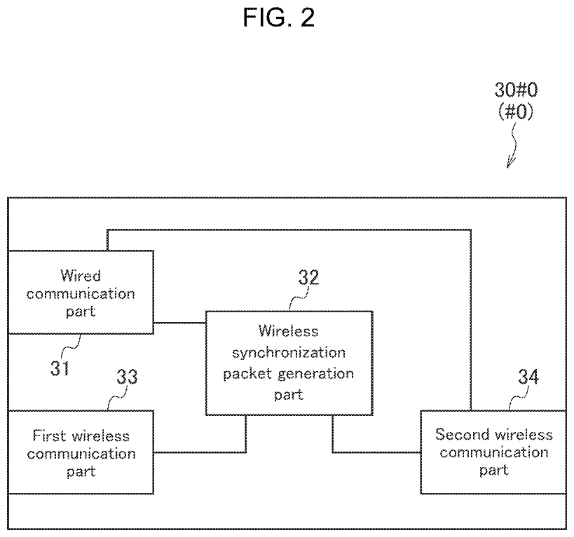

As illustrated in FIG. 2, the wireless access point 30 #0 includes a wired communication part 31, a wireless synchronization packet generation part 32, a first wireless communication part 33, and a second wireless communication part 34.

It is structured that the wired communication part 31 performs communication with the master device 10 via the wired network #0.

It is structured that the wireless synchronization packet generation part 32 generates a wireless synchronization packet with a wireless synchronization period synchronized with at least one of a control period and a communication period of the master device 10.

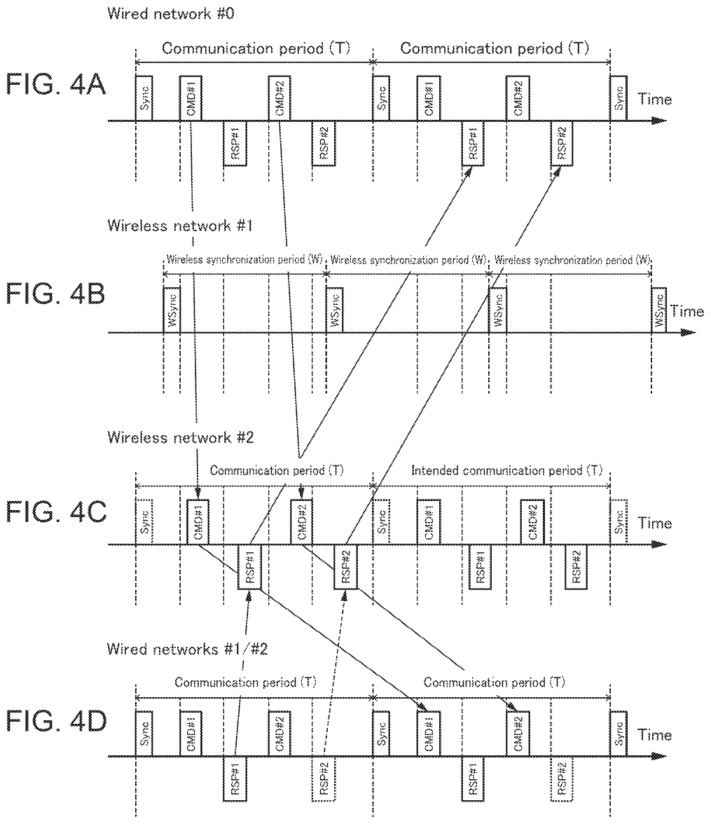

For example, it is structured that the wireless synchronization packet generation part 32 generates a wireless synchronization packet (WSync) (see FIG. 4B to be described later) with a wireless synchronization period (W) (see FIG. 4B to be described later) based on a synchronization packet (Sync) (first synchronization packet, see FIG. 4A to be described later) received with a communication period (T) (first communication period, see FIG. 4A to be described later) by the wired communication part 31 from the master device 10 via the wired network #0.

It is structured that the first wireless communication part 33 transmits the wireless synchronization packet generated by the wireless synchronization packet generation part 32 to the slave devices #1/#2 via the wireless network #1.

Specifically, it is structured that the first wireless communication part 33 transmits the wireless synchronization packet generated by the wireless synchronization packet generation part 32 to the wireless access point #1 via the wireless network #1, and the wireless access point #1 forwards the wireless synchronization packet to the slave device #1 via the wired network #1.

Similarly, it is structured that the first wireless communication part 33 transmits the wireless synchronization packet generated by the wireless synchronization packet generation part 32 to the wireless access point #2 via the wireless network #1, and the wireless access point #2 forwards the wireless synchronization packet to the slave device #1 via the wired network #2.

It is structured that the second wireless communication part 34 communicates via the wireless network #2 communication data communicated via the wired network #0 with the master device 10.

Specifically, it is structured that the second wireless communication part 33 transmits to the wireless access point #1 via the wireless network #2 communication data received by the wired communication part 31 from the master device 10 via the wired network #0, and the wireless access point #1 forwards the communication data to the slave device #1 via the wired network #1.

Similarly, it is structured that the second wireless communication part 33 transmits to the wireless access point #2 via the wireless network #2 the communication data received by the wired communication part 31 from the master device 10 via the wired network #0, and the wireless access point #2 forwards the communication data to the slave device #1 via the wired network #2.

Further, it is structured that the slave device #1 transmits communication data addressed to the master device 10 to the wireless access point #1 via the wired network #1, the wireless access point #1 forwards the communication data addressed to the master device 10 to the wireless access point #0 via the wireless network #2, the second wireless communication part 33 receives via the wireless network #2 the communication data addressed to the master device 10, and the wired communication part 31 transmits the communication data addressed to the master device 10 to the master device 10 via the wired network #0.

Similarly, it is structured that the slave device #2 transmits communication data addressed to the master device 10 to the wireless access point #2 via the wired network #2, the wireless access point #2 forwards the communication data addressed to the master device 10 to the wireless access point #0 via the wireless network #2, the second wireless communication part 33 receives via the wireless network #2 the communication data addressed to the master device 10, and the wired communication part 31 transmits the communication data addressed to the master device 10 to the master device 10 via the wired network #0.

According to such a structure, an industrial machine system 1 using a wireless network can be constructed even when an existing master device built for a wired network is used. Further, according to such a structure, a wireless access point does not depend on a device to be connected, and thus, can be applied to many types of devices.

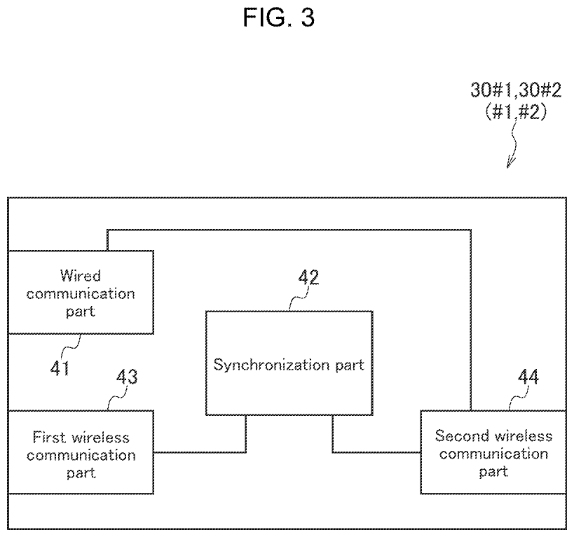

As illustrated in FIG. 3, the wireless access points 30 #1/30 #2 each include a wired communication part 41, a first wireless communication part 42, a synchronization part 43, and a second wireless communication part 44.

It is structured that the wired communication part 41 performs communication with the slave device #1/#2 via the wired network #1/#2.

It is structured that the first wireless communication part 42 receives via the wireless network #1 a wireless synchronization packet generated by the wireless synchronization packet generation part 32 of the wireless access point #0.

It is structured that, based on the wireless synchronization packet received by the first wireless communication part 42, the synchronization part 43 transmits to the slave device #1/#2 via the wired network #1/#2 a synchronization packet (Sync) (second synchronization packet, see FIG. 4D to be described later) for synchronizing at least one of a control period and a communication period of the slave device #1/#2.

It is structured that the second wireless communication part 44 communicates via the wireless network #2 communication data communicated via the wired network #1/#2 with the slave device #1/#2.

Specifically, it is structured that the second wireless communication part 44 of the wireless access point #1 transmits to the wireless access point #0 via the wireless network #2 communication data addressed to the master device 10 received by the wired communication part 41 from the slave device #1 via the wired network #1.

Similarly, it is structured that the second wireless communication part 44 of the wireless access point #2 transmits to the wireless access point #0 via the wireless network #2 communication data addressed to the master device 10 received by the wired communication part 41 from the slave device #1 via the wired network #2.

Further, it is structured that the second wireless communication part 44 of the wireless access point #1 receives communication data addressed to the slave device #1 from the wireless access point #0 via the wireless network #2, and the wired communication part 41 transmits the communication data addressed to the slave device #1 to the slave device #1 via the wired network #1.

Similarly, it is structured that the second wireless communication part 44 of the wireless access point #2 receives communication data addressed to the slave device #2 from the wireless access point #0 via the wireless network #2, and the wired communication part 41 transmits the communication data addressed to the slave device #2 to the slave device #2 via the wired network #2.

According to such a structure, an industrial machine system 1 using a wireless network can be constructed even when an existing slave device built for a wired network is used. Further, according to such a structure, a wireless access point does not depend on a device to be connected, and thus, can be applied to many types of devices.

Here, the master device 10 may have the function of the wireless access point #0. Similarly, the slave device #1 may have the function of the wireless access point #1, and the slave device #2 may have the function of the wireless access point #2.

According to the above-described structure, when synchronization between the master device 10 and the slave devices #1/#2 is performed, the slave devices #1/#2 can be reliably and accurately synchronized with respect to the master device 10.

The wireless access points 30 #0-#2 may have the same function. For example, the wireless access point 30 #0 may have the functions illustrated in FIG. 3 in addition to the functions illustrated in FIG. 2. Similarly, the wireless access points 30 #1/30 #2 may have the functions illustrated in FIG. 2 in addition to the functions illustrated in FIG. 3.

Here, for example, the master device 10 may be any one of a programmable logic controller, a machine controller, a system controller, a robot controller (hereinafter, various controllers), a numerical control device, and a servo amplifier.

Further, the slave devices #1/#2 may each be any one of a servo drive, an inverter drive, a remote I/O, a sensor, a slider, a stepping motor drive, a display, a vision system, various controllers, a servo motor, and an encoder.

According to such a structure, by using the wireless networks #0-#2, an industrial machine system 1 with reduced wiring can be realized and wiring work between the master device 10 and the slave devices #1/#2 can be reduced.

Further, according to such a structure, an industrial machine system allowing relocations and changes of the master device 10 and the slave devices #1/#2 to be flexibly supported can be constructed.

Further, according to such a structure, advanced control in a small space such as the inside of a robot arm can be realized.

In the above-described embodiment, the example in which one master device 10, two slave devices #1/#2, three wireless access points #0-#2, two wireless networks #1/#2, and three wired networks #0-#2 are provided is described. However, the present disclosure is not limited to such an example, and is also applicable to examples in which other numbers of master devices, slave devices, wireless access points, wireless networks, and wired networks are provided.

### Method of Communication of Industrial Machine System

In the following, an example of a method of communication of the industrial machine system 1 according to the present embodiment is described with reference to FIG. 4.

As illustrated in FIG. 4A, the master device 10 transmits a synchronization packet (Sync) to the wireless access point #0 via the wired network #0 in a communication period (T).

As illustrated in FIG. 4B, the wireless access point #0 generates a wireless synchronization packet (WSync) based on the synchronization packet (Sync) in a wireless synchronization period (W), and transmits the wireless synchronization packet (WSync) to the wireless access points #1/#2 via the wireless network #1.

Here, the wireless access points #1/#2 are synchronized with the wireless access point #0 based on the received wireless synchronization packet (WSync).

As illustrated in FIG. 4D, the wireless access points #1/#2 respectively transmit the synchronization packet (Sync) to the slave devices #1/#2 via the wired networks #1/#2 based on the received wireless synchronization packet (WSync) in the communication period (T).

Here, the slave devices #1/#2 are synchronized with the master device 10 based on the received synchronization packet (Sync).

Further, as illustrated in FIG. 4A, the master device 10 transmits communication data (CMD #1) addressed to the slave device #1 to the wireless access point #0 via the wired network #1; as illustrated in FIG. 4C, the wireless access point #0 transmits the communication data (CMD #1) addressed to the slave device #1 to the wireless access point #1 via the wireless network #2; and, as illustrated in FIG. 4D, the wireless access point #1 transmits the communication data (CMD #1) addressed to the slave device #1 to the slave device #1 via the wired network #1.

Then, as illustrated in FIG. 4D, the slave device #1 transmits data (RSP #1) addressed to the master device 10 to the wireless access point #1 via the wired network #1; as illustrated in FIG. 4C, the wireless access point #1 transmits the data (RSP #1) addressed to the master device 10 to the wireless access point #0 via the wireless network #2; and, as illustrated in FIG. 4A, the wireless access point #0 transmits the data (RSP #1) addressed to the master device 10 to the master device 10 via the wired network #0.

Similarly, as illustrated in FIG. 4A, the master device 10 transmits communication data (CMD #2) addressed to the slave device #2 to the wireless access point #0 via the wired network #1; as illustrated in FIG. 4C, the wireless access point #0 transmits the communication data (CMD #2) addressed to the slave device #2 to the wireless access point #2 via the wireless network #2; and, as illustrated in FIG. 4D, the wireless access point #2 transmits the communication data (CMD #2) addressed to the slave device #2 to the slave device #2 via the wired network #2.

Then, as illustrated in FIG. 4D, the slave device #2 transmits data (RSP #2) addressed to the master device 10 to the wireless access point #2 via the wired network #2; as illustrated in FIG. 4C, the wireless access point #2 transmits the data (RSP #2) addressed to the master device 10 to the wireless access point #0 via the wireless network #2; and, as illustrated in FIG. 4A, the wireless access point #0 transmits the data (RSP #2) addressed to the master device 10 to the master device 10 via the wired network #0.

According to the industrial machine system 1 of the present embodiment, even when the wireless networks #1/#2 are used, synchronization can be achieved between the master device 10 and the slave devices #1/#2, and high-precision control can be realized.

In a conventional industrial machine system, there is a problem that when a wireless network using CSMA/CA or the like, which is used as a communication system in many wireless networks, is used as a network, variation occurs in actual transmission and reception timings of synchronization packets and synchronization between a master device and a slave device cannot be achieved.

An industrial machine system, a method of communication and a wireless access point according to embodiments of the present invention allow synchronization between a master device and a slave device to be achieved and high-precision control to be realized even when a wireless network is used.

An industrial machine system according to an embodiment of the present invention includes: a slave device that is an industrial machine component; and a master device that communicates with the slave device and controls the slave device. The slave device and the master device are synchronized via a first wireless network, and communicate communication data for controlling the slave device via a second wireless network which is different from the first wireless network.

Another embodiment of the present invention is a method of communication of an industrial machine system in which the industrial machine system includes: a slave device that is an industrial machine component; and a master device that communicates with the slave device and controls the slave device. The slave device and the master device are synchronized via a first wireless network. The slave device and the master device communicate communication data for controlling the slave device via a second wireless network which is different from the first wireless network.

Yet another embodiment of the present invention is a wireless access point to be used in an industrial machine system in which the industrial machine system includes: a slave device that is an industrial machine component; and a master device that communicates with the slave device and controls the slave device. The wireless access point is connected to the master device via a wired network and includes: a wireless synchronization packet generation part that generates a wireless synchronization packet with a wireless synchronization period synchronized with at least one of a control period and a communication period of the master device; a first wireless communication part that transmits the wireless synchronization packet generated by the wireless synchronization packet generation part to the slave device via a first wireless network; and a second wireless communication part that communicates via a second wireless network the communication data communicated with the master device via the wired network. The wireless synchronization packet generation part generates the wireless synchronization packet with the wireless synchronization period based on a first synchronization packet received with a first communication period from the master device via the wired network.

Still another embodiment of the present invention is a wireless access point to be used in an industrial machine system in which the industrial machine system includes: a slave device that is an industrial machine component; and a master device that communicates with the slave device and controls the slave device. The wireless access point is connected to the slave device via a wired network and includes: a first wireless communication part that receives via a first wireless network a wireless synchronization packet generated by a wireless synchronization packet generation part that generates the wireless synchronization packet with a wireless synchronization period synchronized with at least one of a control period and a communication period of the master device; the synchronization part that transmits to the slave device via the wired network a second synchronization packet for synchronizing at least one of a control period and a communication period of the slave device based on the wireless synchronization packet; and a second wireless communication part that communicates via a second wireless network the communication data communicated with the slave device via the wired network.

An industrial machine system, a method of communication and a wireless access point according to embodiments of the present invention allow synchronization between a master device and a slave device to be achieved and high-precision control to be realized even when a wireless network is used.

Obviously, numerous modifications and variations of the present invention are possible in light of the above teachings. It is therefore to be understood that within the scope of the appended claims, the invention may be practiced otherwise than as specifically described herein.

What is claimed is:

1. An industrial machine system, comprising:
a slave device that is a component of an industrial machine; and
a master device including circuitry configured to communicate with the slave device and control the slave device,
wherein the slave device and the master device are synchronized via a first wireless network, and communicate communication data for controlling the slave device via a second wireless network which is different from the first wireless network.

2. The industrial machine system according to claim 1, wherein the first wireless network is a type of communication system having a constant periodicity.

3. The industrial machine system according to claim 1, wherein the second wireless network is a type of communication system having a higher throughput than the first wireless network.

4. The industrial machine system according to claim 1, wherein a type of communication protocol used in the first wireless network is Bluetooth™ or DECT™, and a type of communication protocol used in the second wireless network is one of Wi-Fi™, Bluetooth™, and DECT™.

5. The industrial machine system according to claim 1, further comprising:
an access point system including first circuitry configured to generate a wireless synchronization packet with a wireless synchronization period synchronized with at least one of a first control period of the master device and a first communication period of the master device, and synchronize at least one of a second control period of the slave device and a second communication period of the slave device based on the wireless synchronization packet acquired via the first wireless network.

6. The industrial machine system according to claim 5, wherein the access point system includes a first wireless access point that is connected to the master device via a wired network and includes the first circuitry, the first circuitry is further configured to transmit the generated wireless synchronization packet to the slave device via the first wireless network, and communicate via the second wireless network the communication data communicated with the master device via the wired network, and the first circuitry is further configured to generate the wireless synchronization packet with the wireless synchronization period based on a first synchronization packet received with a first communication period from the master device via the wired network.

7. The industrial machine system according to claim 5, wherein the access point system includes a second wireless access point that is connected to the slave device via a wired network and includes second circuitry configured to receive the generated wireless synchronization packet via the first wireless network, transmit to the slave device via the wired network a second synchronization packet for synchronizing at least one of the second control period of the slave device and the second communication period of the slave device based on the wireless synchronization packet, and communicate via the second wireless network the communication data communicated with the slave device via the wired network.

8. The industrial machine system according to claim 1, wherein the master device is one of a programmable logic controller, a machine controller, a system controller, a robot controller, a numerical control device, and a servo amplifier, and the slave device is one of a servo drive, an inverter drive, a remote I/O, a sensor, a slider, a stepping motor drive, a display, a vision system, a robot controller, a servo motor, and an encoder.

9. A method of communication of an industrial machine system, comprising:
synchronizing a slave device that is a component of an industrial machine, and a master device that communicates with the slave device and controls the slave device the master device via a first wireless network; and
communicating, using the slave device and the master device, communication data for controlling the slave device via a second wireless network which is different from the first wireless network.

10. A wireless access point of an industrial machine system comprising a slave device that is a component of an industrial machine and a master device that communicates with the slave device and controls the slave device, the wireless access point being connected to the master device via a wired network, comprising:
circuitry configured to generate a wireless synchronization packet with a wireless synchronization period synchronized with at least one of a control period of the master device and a communication period of the master device, transmit the wireless synchronization packet to the slave device via a first wireless network, and communicate via a second wireless network communication data communicated with the master device via the wired network,
wherein the circuitry is further configured to generate the wireless synchronization packet with the wireless synchronization period based on a first synchronization packet received with a first communication period from the master device via the wired network.

11. A wireless access point of an industrial machine system comprising a slave device that is a component of an industrial machine and a master device that communicates with the slave device and controls the slave device, the wireless access point being connected to the slave device via a wired network, comprising:
circuitry configured to receive via a first wireless network a wireless synchronization packet that is generated with a wireless synchronization period synchronized with at least one of a control period and a communication period of the master device, transmit to the slave device via the wired network a second synchronization packet for synchronizing at least one of a control period and a communication period of the slave device based on the wireless synchronization packet, and communicate via a second wireless network communication data communicated with the slave device via the wired network.

12. The industrial machine system according to claim 2, wherein the second wireless network is a type of communication system having a higher throughput than the first wireless network.

13. The industrial machine system according to claim 2, wherein a type of communication protocol used in the first wireless network is Bluetooth™ or DECT™, and a type of communication protocol used in the second wireless network is one of Wi-Fi™, Bluetooth™, and DECT™.

14. The industrial machine system according to claim 3, wherein a type of communication protocol used in the first wireless network is Bluetooth™ or DECT™, and a type of communication protocol used in the second wireless network is one of Wi-Fi™, Bluetooth™, and DECT™.

15. The industrial machine system according to claim 2, further comprising:
an access point system comprising first circuitry configured to generate a wireless synchronization packet with a wireless synchronization period synchronized with at least one of a first control period of the master device and a first communication period of the master device, and synchronize at least one of a second control period of the slave device and a second communication period of the slave device based on the wireless synchronization packet acquired via the first wireless network.

16. The industrial machine system according to claim 3, further comprising:
an access point system comprising first circuitry configured to generate a wireless synchronization packet with a wireless synchronization period synchronized with at least one of a first control period of the master device and a first communication period of the master device, and synchronize at least one of a second control period of the slave device and a second communication period of the slave device based on the wireless synchronization packet acquired via the first wireless network.

17. The industrial machine system according to claim 4, further comprising:
an access point system comprising first circuitry configured to generate a wireless synchronization packet with a wireless synchronization period synchronized with at least one of a first control period of the master device and a first communication period of the master device, and synchronize at least one of a second control period of the slave device and a second communication period of the slave device based on the wireless synchronization packet acquired via the first wireless network.

18. The industrial machine system according to claim 6, wherein the access point system includes a second wireless access point that is connected to the slave device via a wired network and includes second circuitry configured to receive the generated wireless synchronization packet via the first wireless network, transmit to the slave device via the wired network a second synchronization packet for synchronizing at least one of the second control period of the slave device and the second communication period of the slave device based on the wireless synchronization packet, and communicate via the second wireless network the communication data communicated with the slave device via the wired network.

19. The industrial machine system according to claim 2, wherein the master device is one of a programmable logic controller, a machine controller, a system controller, a robot controller, a numerical control device, and a servo amplifier, and the slave device is one of a servo drive, an inverter drive, a remote I/O, a sensor, a slider, a stepping motor drive, a display, a vision system, a robot controller, a servo motor, and an encoder.

20. The industrial machine system according to claim 3, wherein the master device is one of a programmable logic controller, a machine controller, a system controller, a robot controller, a numerical control device, and a servo amplifier, and the slave device is one of a servo drive, an inverter drive, a remote I/O, a sensor, a slider, a stepping motor drive, a display, a vision system, a robot controller, a servo motor, and an encoder.
